(19) United States
(12) Patent Application Publication
(10) Pub. No.: US 2015/0303750 A1
(43) Pub. Date: Oct. 22, 2015

(54) SYNCHRONOUS ELECTRIC MOTOR WITH PERMANENT MAGNETS AND ELECTRIC COMPRESSOR COMPRISING SUCH AN ELECTRIC MOTOR

(71) Applicant: VALEO EQUIPEMENTS ELECTRIQUES MOTEUR, Creteil Cedex (FR)

(72) Inventors: Lilya Bouarroudj, Charenton Le Pont (FR); Mamy Rakotovao, Vitry Sur Seine (FR); Benoit Walme, Feucherolles (FR); Jean-Claude Matt, Dijon (FR)

(73) Assignee: VALEO EQUIPEMENTS ELECTRIQUES MOTEUR, Créteil Cedex (FR)

(21) Appl. No.: 14/440,132

(22) PCT Filed: Oct. 30, 2013
(86) PCT No.: PCT/FR2013/052602

§ 371 Date: May 1, 2015

(30) Foreign Application Priority Data
Nov. 6, 2012 (FR) 1260531

(51) Int. Cl. H02K 1/27; H02K 1/02; F04C 29/00; H02K 1/06

(52) U.S. Cl. CPC H02K 1/2773; H02K 1/06; H02K 1/02; F04C 29/0085

(57) ABSTRACT

Synchronous electric motor with permanent magnets comprising a wound stator (1) comprising stator teeth extending axially formed in a frame and a rotor (5) comprising a plurality of the magnets extending axially into a cylinder head (6), being embedded according to a flux concentration construction of the rotor (5) in which a first length (Ls1) of the rotor (5) is greater than a second length (Ls1) of the stator teeth and in which a ratio of the first length (Ls1) to the second length (Ls2) is lower than 1.3. The compressor comprises such an electric motor.

### TECHNICAL FIELD OF THE INVENTION

The present invention relates to a synchronous motor with permanent magnets for applications in the automobile industry, in particular for an electric compressor.

The invention also relates to an electric compressor comprising this electric motor.

### TECHNOLOGICAL BACKGROUND OF THE INVENTION

At present, ecological considerations, and in particular the fight against global warming, are in favour of the development of electric vehicles.

However, the batteries of these vehicles are sensitive to climatic conditions, and the autonomy of the vehicle can be greatly reduced in the most difficult conditions. An air conditioning system is therefore necessary.

In vehicles with a thermal engine, the compressor of the air conditioning system is generally coupled mechanically to this engine.

In electric vehicles, the compressor is driven by an electric motor which must comply with many constraints, not only in terms of power, torque and speed of rotation, but also in terms of size and weight.

A motor of this type has been discussed in an article presented in the conference “Progress in Electromagnetism Research Symposium” in 2011 in Marrakesh, Morocco, by M. Khanchoul et al (“Design and study of a permanent magnet synchronous motor”), p. 160. PIERS, 20-23 Mar. 2011).

This is a synchronous motor with permanent magnets of the NdFeB type, with a nominal power of 6 kW, with maximum torque of 6 Nm and a maximum speed of 10,000 rpm. The weight of the motor is less than 2 kg, and its length is less than 50 mm. In this type of motor, the permanent magnets are of the surface type, and are implanted on the outer periphery of the rotor. These magnets are retained by a collar.

In order to satisfy ever increasing constraints of compactness, the need has arisen for a motor with the same nominal performance, but with a reduced length and weight.

### GENERAL DESCRIPTION OF THE INVENTION

The objective of the present invention is therefore to satisfy this need.

Its subject is specifically a synchronous electric motor with permanent magnets of the type comprising a wound stator comprising stator teeth which extend axially and are formed in a casing, and a rotor comprising a plurality of these magnets which extend axially in a head, and are embedded according to an architecture with flux concentration.

This synchronous electric motor with permanent magnets is distinguished in that a first length of the rotor is longer than a second length of the stator teeth, and in that a ratio of the first length to the second length is less than 1.3.

According to other characteristics considered in isolation or in combination:

This ratio is predetermined such that this first length is shorter than a third predetermined length, and electrical performance of the motor, comprising torque and output, are substantially equal to, or greater than predetermined nominal values.

This ratio is highly advantageously predetermined such that a first contribution of a three-dimensional magnetic flux between the stator teeth and the rotor is substantially equal to, or greater than, a second contribution of a two-dimensional magnetic flux in an air gap between a reference stator and a reference rotor, each having this third predetermined length in an electric reference motor with the same predetermined nominal values.

Advantage is derived from the fact that this ratio is also predetermined such as to minimise an increase in weight of the permanent magnets and an increase in material, as well as decreases in production of the head and the casing.

This ratio is preferably between 1.2 and 1.3.

The magnets are embedded according to an architecture of the said rotor with radial orientation.

The rotor comprises a head with a central core and arms which extend radially relative to the central core.

The arms each comprise on their outer periphery two rims which extend on both sides of the arm.

The permanent magnets are accommodated in recesses in the head which are each delimited by two lateral surfaces opposite one another of two adjacent arms, an outer surface of the core extending between the two adjacent arms and the rims of the two adjacent arms of the rotor.

In the synchronous electric motor with permanent magnets according to the invention, the permanent magnets are also advantageously constituted by ferrite.

The head and the casing of the synchronous electric motor with permanent magnets according to the invention are also each highly advantageously constituted by a stack of plates.

The number of stator teeth is greater than the number of permanent magnets.

The invention also relates to an electric compressor for a coolant fluid which is designed for an air conditioning installation, distinguished in that it comprises a spiral driven by the synchronous electric motor with permanent magnets with the above characteristics.

These few essential specifications will have made apparent to persons skilled in the art the advantages provided by the synchronous electric motor with permanent magnets according to the invention, as well as by the electric compressor which uses it, in comparison with the prior art.

The detailed specifications of the invention are provided in the description which follows in association with the accompanying drawings. It should be noted that these drawings serve the purpose simply of illustrating the text of the description, and do not constitute in anyway a limitation of the scope of the invention.

### BRIEF DESCRIPTION OF THE DRAWINGS

FIG. 1a is an exploded view of the sets of plates of a stator/rotor assembly of a synchronous electric motor with permanent magnets according to the invention.

FIG. 1b is a view in perspective of the stator and the rotor shown in FIG. 1a, corresponding to a partial view of a synchronous electric motor with permanent magnets according to the invention, the rotor being arranged opposite the stator.

FIG. 2 is a lateral view corresponding to the view in perspective of FIG. 1b.

FIG. 3 shows the effect of the ratio between the first length of the rotor and the second length of the stator on the magnetic flux in the air gap of a synchronous electric motor with permanent magnets of the type according to the invention.

FIG. 4 is a view in perspective of the stator without its coils.

FIG. 5 is a view in perspective of the stator with its coils.

FIG. 6 is a partial view from above of the rotor equipped with its magnets and springs, one of the recesses for accommodation of a magnet being without its magnet.

FIG. 7 is a view in perspective of the rotor equipped with its flanges with balancing weights.

### DESCRIPTION OF THE PREFERRED EMBODIMENT OF THE INVENTION

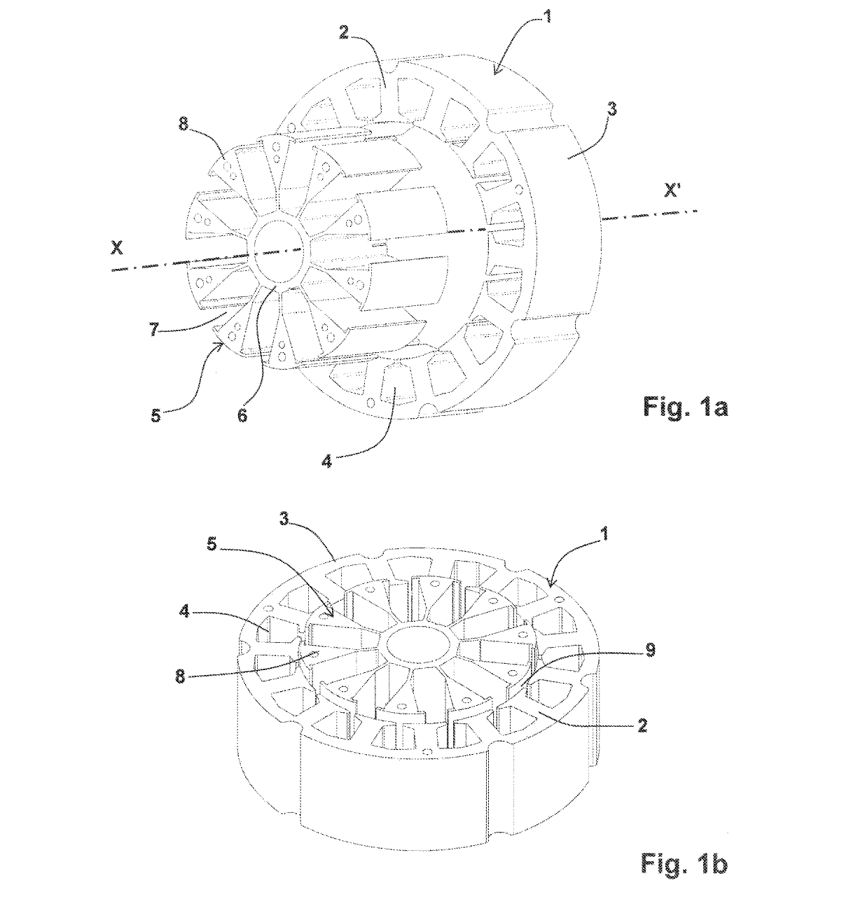

The stator 1 of a synchronous electric motor with permanent magnets represented in FIGS. 1a, 1b, 4 and 5 comprises stator teeth 2, also known as stator arms, which are distributed regularly in a circumferential direction, and extend according to an axial direction XX′ in a casing 3 formed by a stack of plates. Hereinafter in the description, the terms axial, radial and transverse will be made with reference to the axis XX′ of the stator 1 which is hollow in the centre for implantation of a rotor 5. The axis XX′ constitutes the axis of rotation of the motor.

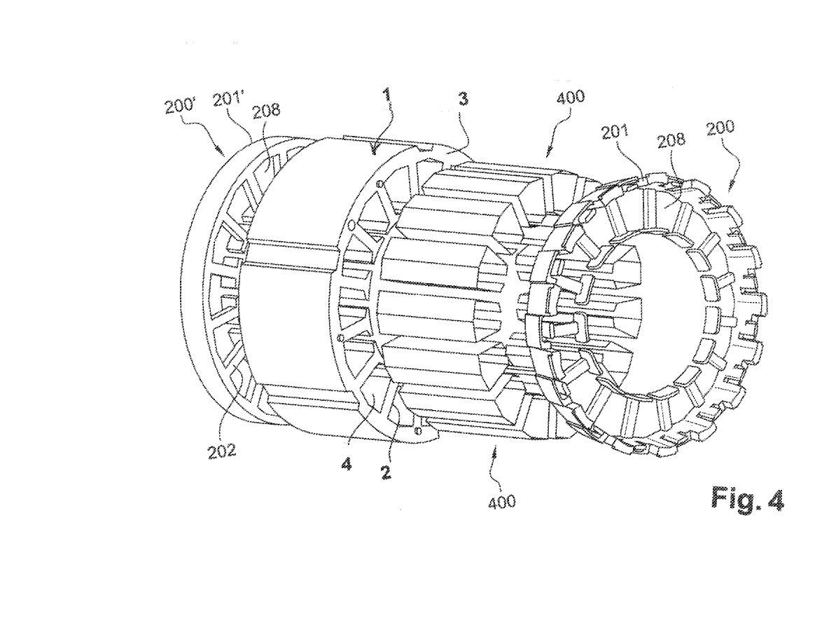

The casing 3 is configured to be supported by a housing which the electric motor comprises. Longitudinal cavities 4 in the form of notches of the semi-open type in this embodiment are present between two consecutive teeth 2. These notches 4 are each provided with a notch insulator 400 shown in FIG. 4, which is identical to FIG. 11 of application FR 12/55481 filed on 12 Jun. 2012. This insulator 400 is in the form of a fine membrane made of a material which is electrically insulating and a good conductor of heat such as an aramid material of the Nomex type (registered trademark). The insulators 400 match the contour of the notches 4 and are therefore open at the level of the space between two consecutive teeth, as shown in FIG. 4. In this embodiment, the insulators 400 have a thickness of 0.24 mm. It will be appreciated that this depends on the applications.

The longitudinal cavities 4 between the stator teeth 2 are designed to receive the continuous conductive wires of stator windings which create the rotary magnetic field. These conductive wires are electrically conductive, they are made for example of copper and/or aluminium, and are covered with an electrically insulating layer such as enamel.

The stator windings can be designed to form for example a synchronous electric motor of the three-phase type with a neutral point as described for example in document EP 0 831 580, to which reference will be made for further details.

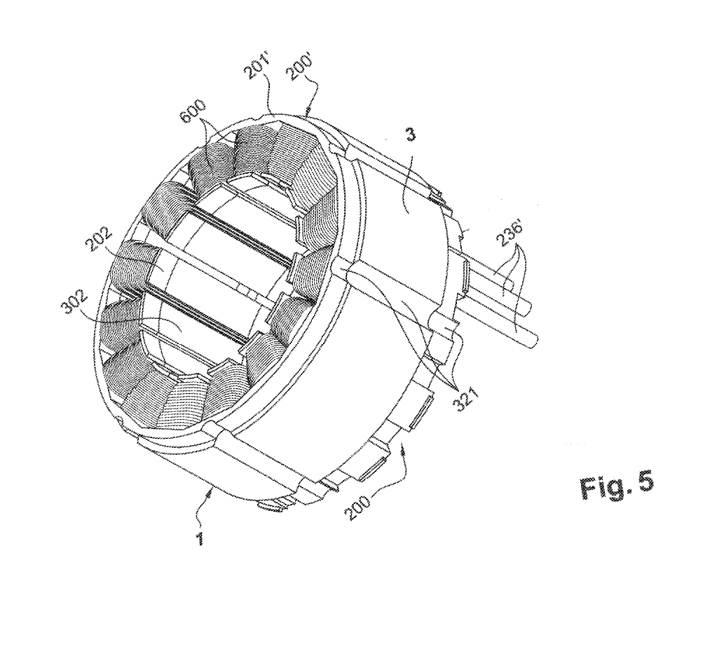

Thus, FIG. 5 shows the three ends 236′ of the stator windings of the three-phase type. These ends 236′ are configured to be connected to the arms of the inverter shown in this document EP 0 831 580.

Each phase comprises at least one stator winding in the form of a coil 600 (FIG. 5) comprising turns. These turns can be formed by winding conductive wires around a tooth 2 with interposition of the notch insulator 400 for formation of a coil 600. These windings are produced for example by means of a hollow needle into which the wire penetrates, with the needle executing the winding movement by being displaced for this purpose axially, radially and circumferentially in the notches 4. There is a larger number of wires arranged on the outer periphery of a notch 4 than on the inner periphery of a notch 4. A space exists between the two coils 600 of a single notch 4, which are each wound around one of the teeth which delimit the notch 4. The ends 236′ are sheathed in order to be insulated against the coils. A tie is provided in order to retain these ends 236′.

According to one embodiment (FIGS. 4 and 5), the stator 1 can be equipped with electrically insulating elements 200, 200′ at each of the ends of its casing 3 for formation of coils 600, the said elements being in contact with the arms or teeth 2 of the stator 1, as described in the aforementioned application FR 12/55481, to which reference will be made. Insulating elements 200, 200′ are equipped with arms 202 which extend from a support 201, 201′. Two consecutive arms 202 delimit a notch 208 which is like the notch 4′. The elements 200, 200′ are for example made of plastic material such as PA 6.6 which can be reinforced by fibres such as glass fibres. They are thicker than the insulators 400. The arms 202 have projecting feet (FIG. 4) for formation of grooves for the turns. These grooves are delimited at their outer periphery by the inner periphery of the supports 201, 201′. The coils 600 pass through the set of plates of the stator 1, and have on both sides of this set of plates chignons which are mounted in the grooves of the elements 200, 201′, as can be seen in FIG. 5. The inner periphery of the arms 202 is aligned with the inner periphery 302 of the teeth 2, as shown in FIG. 5. The turns of the coils 600 are protected by the elements 201, 201′ and the insulators 400. The arrangement of the coils 600 in a concentric manner makes it possible to reduce the axial length of the stator 1.

It will be appreciated that, as a variant, the stator windings can be of the pentaphase or hexaphase type. In all cases, the outputs of the stator windings are connected to the arms of an inverter which belongs to an electronic command and control device, for example of the type described in document EP 0 831 580, supported by the housing of the electric motor.

The synchronous electric motor can belong to an electric compressor for a coolant fluid, for example of the type with at least two spirals. This type of compressor with spirals is known as a scroll compressor. It is designed for an air conditioning installation in particular of a motor vehicle, as disclosed in the aforementioned article. It will be remembered that one of the spirals is fixed, whereas the other spiral is mobile in the fixed spiral. In this case, the housing of the electric motor can comprise a plurality of sections, i.e. a front section containing the system with two spirals, which are also known as volutes, one of which is mobile and the other one of which is fixed, in order to pump and compress the coolant fluid, a central section through which the coolant fluid passes, and which supports the stator 1, and a rear section comprising a flange. The flange can support the command and control electronics dedicated to the coils of the stator windings. As a variant, the command and control electronics can be supported by the central section of the housing.

The electric motor comprises a rotor 5 with the presence of an air gap 9 between the inner periphery of the stator 1, comprising the inner surface 302 of the teeth 2, and the outer periphery of the rotor 5 which is integral with a shaft. This shaft can drive the mobile spiral of the compressor directly.

The aforementioned article gives an example of the structure of the compressor.

The rotor 5, which is in the general form of a cylinder, comprises a head 6, which is also formed by a stack of plates integral with the aforementioned shaft. This shaft can for example be knurled locally, and can be forced into the central opening in the stack of plates.

For economic reasons, these plates can be cut at the same time as those of the casing 3.

Permanent magnets, which have the reference 114 in FIG. 6, are embedded in the head 6 of the rotor 5 according to an architecture with flux concentration.

For this purpose, in this embodiment, recesses 7 extend in the head 6 according to the axial direction XX′, and are designed to receive the permanent magnets 114. The recesses 7 are distributed regularly circumferentially.

These recesses 7 receive the magnets 114, such as to form a plurality of north and south poles 8 which are distributed regularly in the peripheral part of the rotor 5. One of the lateral surfaces of the magnet 114 constitutes the north pole, whereas the other lateral surface of this magnet constitutes a south pole.

More specifically, as shown in FIGS. 1a, 1b and 6, the rotor 5 can comprise:

a head 6 with a central core;

arms 8 which extend radially relative to the core, these arms each comprising on their outer periphery two rims 105 which extend on both sides of the arm;

permanent magnets 114 (see FIG. 6) positioned in the interior of the recesses 7 which are each delimited by two lateral surfaces 112 opposite one another of two adjacent arms, with an outer surface of the core extending between the two adjacent arms and the rims of the two adjacent arms of the rotor.

The magnets 114 have radial orientation with reference to FIG. 6. The extend axially into the head 6.

The recesses 7 in the head 6 constitute receptacles for the permanent magnets which are arranged between two consecutive poles 8. These 114 have radial orientation just like the recesses 7. They generate a useful magnetic flux from the rotor 5 to the teeth 2 of the stator 1. This useful magnetic flux circulates globally radially in the poles 8, which alternate regularly in a plurality of north and south poles.

The poles 8 are each formed by an arm which extends radially, and comprises on its outer periphery two rims 105 which extend on both sides of the arm. More specifically, each arm, and therefore each pole 8, comprises a first portion with orientation which is globally radial relative to the axis XX′, and has a constant width, extending from the central core of the head 6, and a second portion 112 which widens in the direction opposite the axis XX′, and ends in rims 105. The recesses 7 have a form complementary to that of the magnets 114. These magnets 114 occupy to the maximum extent the space which is available in the rotor 5, and have a parallelepiped form with a constant width at the level of the two portions 112 of the arms 8 and two angles which are bevelled at their inner periphery at the level of the first portions of the arms. The magnets 114 thus have a substantially rectangular cross-section, but are chamfered in the form of a wedge towards the axis XX′. Small plates 119 (FIG. 6), which for example are made of plastic material, can be interposed between the inner surfaces of two consecutive rims 105, delimiting a recess 7 on the exterior, and the outer surface of the magnet 114 which is accommodated in the recess 7. The small plates 119 are more flexible than the magnets 114, and protect the latter by preventing the magnets 114 from breaking under the action of the centrifugal force. If a single pole 8 is taken into consideration, this pole is interposed, depending on the case in question, between two north or south surfaces of two consecutive magnets, for formation respectively of a north pole and a south pole.

The rotary electrical machine can thus have maximum power, whilst being compact radially. In this embodiment, ten recesses 7 and fifteen stator teeth 2 are provided.

It will be noted that the number of magnets 114 and of stator teeth is greater than that of the aforementioned document, in which six stator teeth and eight surface magnets are provided. In addition, in this document, use is made of rare earth magnets of the neodymium-iron-boron (NdFeB) type. In the embodiment described, the magnets 114 can be more economical ferrite magnets. In addition, it is possible to reduce the air gap 9 between the stator 1 and the rotor 5, since in this embodiment no collar is provided, thus making it possible to increase the power of the machine. Consequently 0.15 mm is gained, corresponding to the thickness of the collar. Thus, the air gap between the stator and the rotor can be equal to 0.50 mm or less. The plates of the stack of plates of the stator 1 and of the rotor 5 can have a thickness of 0.35 mm, just as in the aforementioned document.

As described in application FR 12/54949 filed on 30 May 2012, to which reference will be made, this rotor 5 can comprise:

springs 122 (FIG. 6) which are positioned in the interior of the recesses 7, between the outer surface of the core of the head 6 and an inner surface of the magnet 114 which faces towards the axis XX′ of the rotor 5, these springs ensuring retention of the permanent magnet 114 in the interior of its receptacle, formed by the recess 7, against the small plate 119 concerned, supported on the rims 105 of the arms 8 concerned by exerting a radial force F1 by deformation on the permanent magnet 114 from the interior towards the exterior of the rotor 5.

The springs 122 can work in an elasto-plastic domain.

These springs 122 each have a linear contact C1 with the inner periphery of the magnet 114, constituted by the inner surface of the latter, and two linear contacts C2 with the outer surface of the core of the head 6. These springs 122 each comprise a bevelled end comprising a slot (with no reference) to reduce the rigidity of the bevelled end. In this embodiment, each spring 122 comprises a central rounded portion and two end rounded portions which are configured to form the contacts C2. These rounded portions are situated on both sides of the central rounded portion which is configured to form the contact C1.

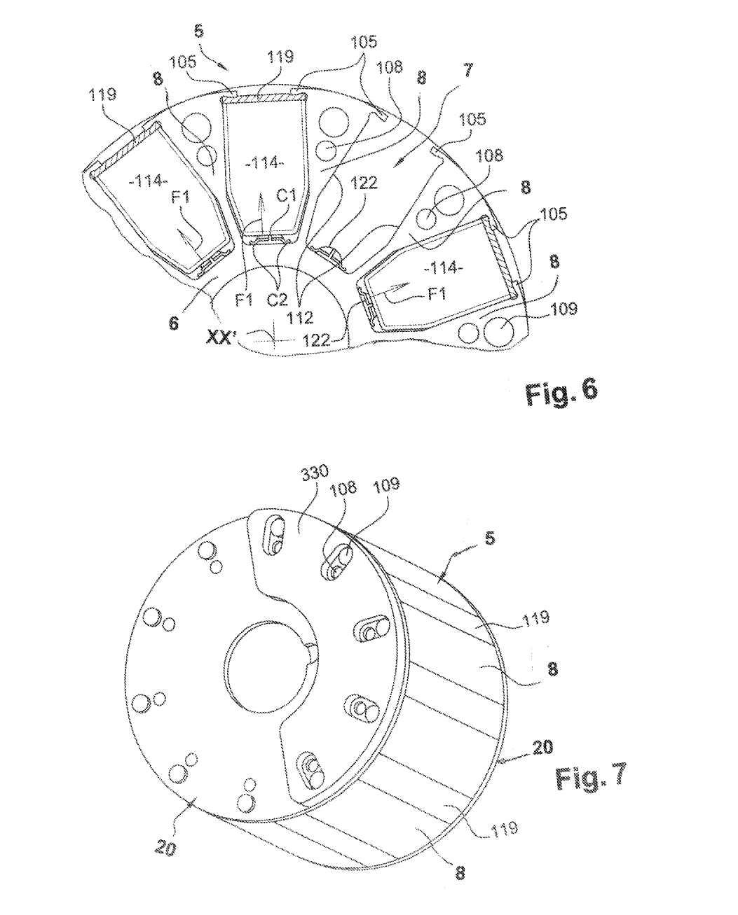

It will be noted that the poles 8 in this embodiment are perforated, in particular for the passage of rivets, preferably made of non-magnetic material, for assembly of the stack of plates of the rotor, as described in the aforementioned application FR 12/54949. More specifically, as shown in FIG. 7, the plates of the rotor 5 are perforated for passage of the aforementioned assembly rivets 108 which pass through the stack of plates for formation of a set of plates which can be manipulated and transported. This stack of plates also comprises other through openings to receive tie rods 109, preferably made of non-magnetic material, for assembly of two flanges 20 made of non-magnetic material, placed on both sides of the set of plates of the rotor 5. The flanges 20 are for example made of aluminium or plastic material, whereas the rivets 108 and the tie rods 109 are for example made of stainless steel.

Each flange 20 can support a balancing weight with the reference 330 in FIG. 7. The weights 330 are diametrically opposite from one flange 20 to the other flange 20. These weights 330 can be heavier than the flanges 20, and can for example be made of brass. The weights 330, in the form of a half ring, have hollows with an oblong form for receipt of the rivets 108. The hollows have locally a perforated base for support of the heads of the tie rods 109, which also constitute tie rods for assembly of the weights 330 with the flanges 20.

The presence of the weights 330 is not imperative, and as a variant the flanges 20 can have a plurality of projections, some of which can be machined, for balancing of the rotor. As a variant, the projections are hollow, and some of them can be equipped with weights which are crimped in the projections for balancing of the rotor.

The head 3 and the elements 200, 200′ can have on their outer periphery passages, with the reference 321 in FIG. 5, for tie rods for assembly of the front and rear sections of the housing of the electric motor. These passages are implanted opposite teeth 2 and arms 202. It will be noted that the outer diameter of the insulating elements 200, 200′ is smaller than that of the stack of plates of the stator 1. The head 3 also has openings for receipt of pins which the elements 200, 200′ comprise at the level of their surface which is designed to come into contact with the end concerned of the stack of plates of the stator. In this embodiment, the pins are snap-in pins, which each have two portions of cylinder with flat surfaces which are opposite one another, and are separated by a space which permits resilient deformation of the two portions towards one another when they are inserted in the opening concerned in the head. In the aforementioned manner, the number of teeth 2 is greater than the number of poles 8 and magnets.

According to an embodiment described in application FR 12/54949, it is indicated by way of non-limiting example that the stack of plates of the rotor 5 has a length equal to 41 mm, and the outer diameter of this rotor is 61 mm. In practice, the length of the stack of the set of plates of the rotor is identical to that of the set of plates of the stator, as can be seen for example in FIG. 1 (b) of document EP 2 506 399. This identical length constitutes a reference value Lm, known hereinafter as the third length. This type of synchronous electric motor with permanent magnets constitutes an electric reference motor.

In a non-limiting manner, the inventive body has constructed an electric reference motor with a third length Lm equal to 41 mm, and with an outer diameter of the rotor equal to 61 mm. In this prototype of the electric motor, the outer diameter of the stack of the plates of the stator, which constitutes a set of plates, was globally 100 mm, and the inner diameter of the said stack was 62 mm.

Computer simulations of a synchronous electric motor with permanent magnets of the type according to the invention, in particular by means of calculation of three-dimensional magnetic flux, have allowed the inventive body to determine that the electrical performances, such as the torque and the output, were increased by making a first axial length Lr1 of the rotor 5 longer than a second axial length Ls1 of the stator 1 (see FIG. 3).

The inventive body therefore decided to improve this prototype of an electric motor by making a first length Ls1 of the said rotor 5 longer than a second length Ls2 of the said stator teeth 2, and by creating a ratio r of the said first length Ls1 to the said second length Ls2 lower than 1.3.

The increase in the electrical performance made it possible to make the length Ls1 shorter than the third length Lm of the reference motor, which in the embodiment was equal to that indicated in the aforementioned article.

FIG. 1b shows clearly an end of the rotor 5 extending from the air gap 9 between the stator teeth 2 and the poles 8 of the rotor 5.

Thus, it is possible to reduce the axial size of the motor according to the invention, whilst retaining the same predetermined nominal values of an electric reference motor.

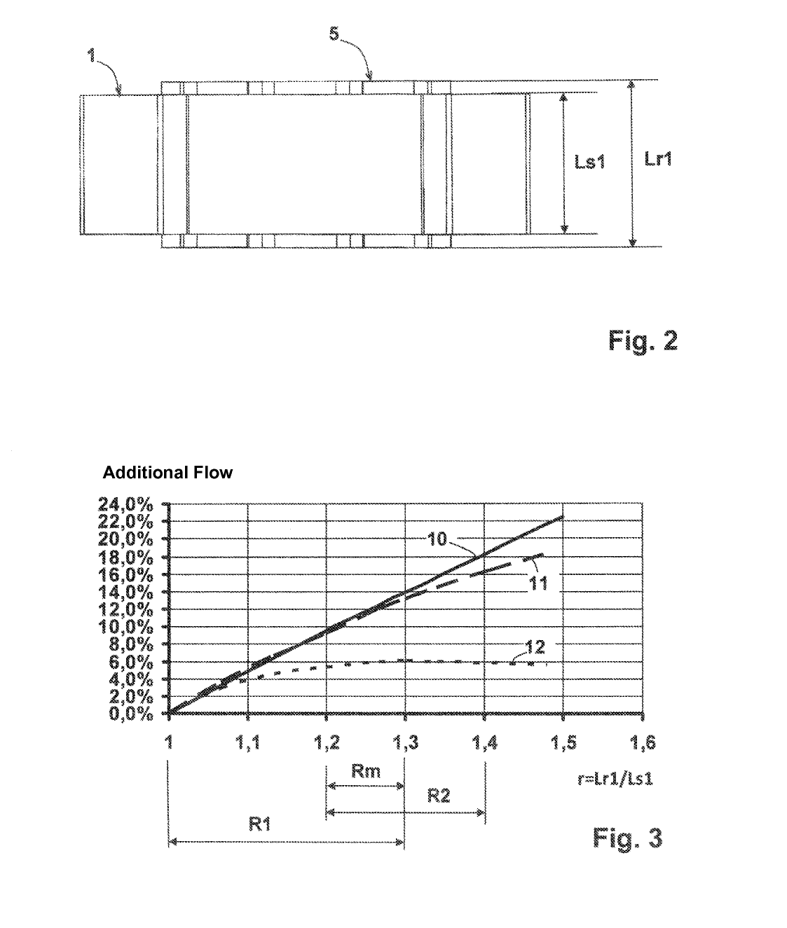

FIG. 2 shows the dimensional characteristics in question.

The first length Lr1 of the rotor 5 is a distance between the radial end surfaces of the rotor 5. In this preferred embodiment, this distance is equal to an axial length of the permanent magnets. As shown clearly in FIG. 2, the rotor 5 is arranged symmetrically relative to the stator 1.

The second length Ls1 corresponds to a thickness of a set of plates which forms the casing 3, i.e. the second axial length of the stator teeth 2. The additional parameters selected by the inventive body for the simulations which it carried out are other dimensional characteristics, i.e.:

Lm: aforementioned third length of the stator 1 or the rotor 5 of the reference motor (Ls0 or Lr0);

Ns0: aforementioned number of reference turns of the stator 1 of the reference motor;

Ns1: number of turns of the stator 1 of the motor according to the invention; and functional characteristics:

LD0, LQ0: reference stator inductances of the stator 1 of the reference motor (axes direct and in quadrature);

LD1, LQ1: stator inductances of the stator 1 of the motor according to the invention (axes direct and in quadrature);

Rs0: reference stator resistance of the reference motor;

Rs1: stator resistance of the motor according to the invention;

Kt0: reference torque constant of the reference motor;

Kt1: torque constant of the motor according to the invention.

These dimensional and functional characteristics are associated:

the stator resistances Rs are proportional to the number of turns of the stator, to the square Ns², and to the third length Lm;

the stator inductances LD, LQ also proportional to the number of turns of the stator 1, to the square Ns², and to the third length Lm;

the torque constants Kt are proportional to the number of turns of the stator 1 Ns, and to the third length Lm.

The objective is to obtain an optimised motor with the same characteristics (torque, output) as the reference motor, but shorter (reduction of cost and weight).

In order to have the same characteristics, it is necessary to have the same values of torque constant Kt, stator resistance Rs, and stator inductance LD, LQ, i.e.:

Condition 1:

The conditions of preservation of Rs and LD, LQ mean that:

Ns1/Ns0=(Ls0/Ls1)^{1/2}

Condition 2:

The conditions of preservation of Kt mean that:

Ns1/Ns0=(Ls0/Ls1)

These conditions are summarised in table 1 below:

TABLE 1
Ns1/Ns0

| | Condition 1 | Condition 2 | |
|---|---|---|---|
| Ls0/Ls1 | (Ls0/Ls1)^{1/2} | Ls0/Ls1 | Flux requirement |
| 1 | 1.00 | 1.00 | 0 |
| 1.1 | 1.05 | 1.10 | 4.9% |
| 1.2 | 1.10 | 1.20 | 9.5% |
| 1.3 | 1.14 | 1.30 | 14.0% |
| 1.5 | 1.22 | 1.50 | 22.5% |

The two conditions are impossible to obtain simultaneously, except for Ls1=Ls0, i.e. for a second length of the stator 1 which is identical to the third length Lm of the reference motor, which is not the objective sought.

For the application envisaged for the electric compressors, the first condition is the most important one, since running at high speed is not possible if the preservation of the stator inductances LD, LQ is not maintained.

The choice of Ns1 is therefore dictated by the first condition, and, so as to comply with the second condition, the loss of Kt must be compensated for by a supplementary added magnetic flux as indicated in table 1.

A first solution for obtaining this additional amount would consist of using permanent magnets with higher remnant magnetic induction than the magnets of the reference motor.

In the reference motor, the magnets consist of ferrite and their replacement by rare earth magnets, for example, would lead to an increase in the production costs. This first solution was not selected by the inventive body.

In application of the increased performance obtained by a first length Lr1 of the rotor 5 longer than a second length Ls1 of the stator 1 revealed by the computer simulations, the inventive body determined a ratio r=r1/Ls1 making it possible to obtain the supplementary added magnetic flux made necessary by compliance with the second condition.

The following table II shows the supplementary magnetic flux obtained by a first contribution of the three-dimensional magnetic flux, in particular between the radial surfaces of the stator teeth 2 and the ends of the poles 8 of the rotor 5, relative to a second contribution of a two-dimensional magnetic flux (i.e. corresponding to magnetic induction without an axial component) in the air gap 9 between a stator and a rotor with the same third length Lm.

TABLE II

| | | | | | | | | | | |
|---|---|---|---|---|---|---|---|---|---|---|
| | r = Lr1/Ls1 | 1.00 | 1.07 | 1.13 | 1.20 | 1.27 | 1.30 | 1.34 | 1.41 | 1.48 |
| | Added 3D % | 0.0 | 3.6 | 6.6 | 9.3 | 12.0 | 13.2 | 14.4 | 16.4 | 18.3 |
| Flux | 1.1 | 4.9 | 4.9 | 4.9 | 4.9 | 4.9 | 4.9 | 4.9 | 4.9 | 4.9 |
| requirement | 1.2 | 9.5 | 9.5 | 9.5 | 9.5 | 9.5 | 9.5 | 9.5 | 9.5 | 9.5 |
| Ls0/Ls1 | 1.3 | 14.0 | 14.0 | 14.0 | 14.0 | 14.0 | 14.0 | 14.0 | 14.0 | 14.0 |

The shortening solution is optimum if the equation Lr1/Ls1<Ls0/Ls1 is approximately verified, whilst ensuring that the supplementary added flux is sufficient for the second condition of preservation of the torque constant Kt to be fulfilled.

FIG. 3 illustrates this solution according to the data in table III, which summarises tables I and II. The solid straight line 10 indicates the magnetic flux to be added according to the ratio r=Lr1/Ls1. The curve in a broken line 11 indicates the flux added by 3-D effect according to this ratio r.

If this first criterion were to be strictly complied with, the optimum ratio r=Lr1/Ls1 should be less than 1.2.

A ratio r of approximately 1.3, leading to a criterion approximately complied with is still acceptable with a first length Ls1 which is slightly longer than the third length Lm of the reference stator of the reference motor.

Beyond this first range R1 of ratios, the economic gain is low, even if the weight of the copper used for the stator windings has decreased, since the weight of the iron of the rotor 5 has increased, as have the losses corresponding to the stator plates 1 not used. In addition, the size of the machine becomes disadvantageous, which does not correspond to the initial requirements.

A factor of weighting of the added magnetic flux equal to the ratio r to the cube, representing an additional cost in terms of weight of magnet, weight of plates and losses, leads to a second criterion with an extremum in a second range R2 between 1.2 and 1.4, as shown clearly by the curve in a dotted line 12 in FIG. 3.

The combination of these two criteria leads to an optimum range Rm of the ratio r according to the invention, contained substantially between 1.2 and 1.3.

TABLE III

| | | | | | | | | | |
|---|---|---|---|---|---|---|---|---|---|
| r = Lr1/Ls1 | 1.00 | 1.07 | 1.13 | 1.20 | 1.27 | 1.30 | 1.34 | 1.41 | 1.48 |
| Add. flux (requirement) % | 0.0 | | 4.9 | 9.5 | | 14.0 | | | 22.5 |
| Add. flux (3D)% | 0.0 | 3.6 | 6.6 | 9.3 | 12.0 | 13.2 | 14.4 | 16.4 | 18.3 |
| Add. flux (3D)/r³ % | 0.0 | 2.96 | 4.53 | 5.36 | 5.90 | 6.01 | 5.98 | 5.85 | 5.65 |

In addition, the decrease in the second length Ls1 of the stator 1 makes it possible to reduce the stator inductances LD1, LQ1 of the electric motor according to the invention, which reduces the induced voltage at the terminals of the stator phases, and allows the motor to reach high speeds of rotation.

According to a particular embodiment of this motor, the rotor 5 comprising ten permanent magnets rotates inside a stator comprising fifteen stator teeth 2.

The magnets consist of ferrite, and are arranged in the recesses 7 in the head 8 in the manner previously described, according to a flux concentration architecture.

A reference motor, in which the third length Lm of the reference stator and of the reference rotor was 41 mm, was shortened into a motor according to the invention with superior electrical performance comprising stator teeth 2 with a second length contained between 28 and 35 mm, and a rotor 5 with a first length contained between 36 and 40 mm, without the grade of magnets being modified.

According to an embodiment of the electric motor according to the invention, the wires of the coils covered with enamel have a diameter contained between 0.53 and 0.63 mm.

It will be noted that the diameter of the wires is decreased relative to the diameter of the wires indicated in the aforementioned article (diameter of 1.4 mm).

In this embodiment, the outer diameter of the stator is globally 100 mm.

It is apparent from the foregoing description that the gain in the axial direction XX′, which can be 10 mm, at the level of the stator windings, has made it possible in particular to clear a space for connectors, and thus to render more compact the electric compressor with a volute or spirals of the scroll type, in which the motor according to the invention is used.

It will also be noted that the general structure of the rotor 5 with recesses 7 and of the stator 1 with notches 4 has been retained.

It will be appreciated that the invention is not limited simply to the above-described preferred embodiment, and in particular the numbers of magnets and stator teeth 2 indicated are only examples.

As a variant, the rotor 5 does not necessarily extend beyond the stator 1 symmetrically.

In another variant, the magnets do not necessarily extend along the entire first length of the rotor 5.

According to yet another embodiment, the rotor is without the springs 122.

According to yet another embodiment, the recesses 7 in the rotor 5 can be closed.

According to yet another embodiment, the poles 8 can have on their outer periphery a lobe in order to reduce the magnetic leakages which circulate on the outer periphery of the poles, as described in application FR 11/61016 filed on 1 Dec. 2011, to which reference will be made, the said application disclosing a ratio of the angle of polar covering of a lobe to the polar pitch of between 0.35 and 0.50.

It will be appreciated that it is possible to optimise the poles of the rotor further such as to reduce the magnetic leakages which circulate on the outer periphery of the poles, as described in application FR 11/61019, to which reference will be made. In this application, account is taken of the width of the opening between two consecutive rims 105 of a single recess 7 and of the outer peripheral width of the magnets 114. Advantageously, the ratio between the width of this opening and the width of the magnet is contained between 0.35 and 0.8. The outer periphery of the poles can be in the form of a lobe, or pointed.

According to another embodiment, the permanent magnets can be embedded in the rotor according to an architecture of the said rotor of the flux concentration type using permanent magnets 114 which use pairs of magnets arranged in the form of a “V”, symmetrically relative to the axis of rotation XX′.

An architecture of this type is described for example in application EP 2 506 399, to which reference will be made.

It will be appreciated that the aforementioned numerical values are provided by way of non-limiting example, in the knowledge that conditions 1 and 2 must be fulfilled. The number of teeth 2 and magnets 114 depends on the applications.

The application of the electric motor according to the invention to driving of a compressor of a motor vehicle installation is also only an example of an application: persons skilled in the art will derive advantage from the electric motor according to the invention in other applications where compactness and high speed of rotation are required.

Other embodiments based on different configurations of magnets and/or on numerical values different from those specified above, and corresponding to other tests or simulations of synchronous motors with permanent magnets, would thus not depart from the context of the present invention, provided that they are derived from the following claims.

1. Synchronous electric motor with permanent magnets of the type comprising a wound stator (1) comprising stator teeth (2) which extend axially and are formed in a casing (3), and a rotor (5) comprising a plurality of said magnets which extend axially in a head (6), and are embedded according to an architecture of said rotor (5) of the flux concentration type, characterized in that a first length (Ls1) of said rotor (5) is longer than a second length (Ls2) of said stator teeth (2), and in that a ratio (r) of said first length (Ls1) to said second length (Ls2) is less than 1.3.

2. Synchronous electric motor with permanent magnets according to claim 1, characterized in that said ratio (r) is substantially contained between 1.2 and 1.3.

3. Synchronous electric motor with permanent magnets according to claim 1, characterized in that said ratio is predetermined such that said first length (Ls1) is shorter than a third predetermined length (Lm), and electrical performance of said motor, comprising torque and output, is substantially equal to, or greater than predetermined nominal values.

4. Synchronous electric motor with permanent magnets according to claim 1, characterized in that said ratio (r) is predetermined such that a first contribution of a three-dimensional magnetic flux between said stator teeth (2) and said rotor (5) is substantially equal to, or greater than, a second contribution of a two-dimensional magnetic flux in an air gap (9) between a reference stator and a reference rotor, each having said predetermined length (Lm) in an electric reference motor with said predetermined nominal values.

5. Synchronous electric motor with permanent magnets according to claim 1, characterized in that said ratio (r) is also predetermined such as to minimize an increase in weight of said permanent magnets and an increase in material, as well as decreases in production of said head (6) and said casing (3).

6. Synchronous electric motor with permanent magnets according to claim 1, characterized in that said permanent magnets are embedded according to an architecture of said rotor (5) of the type with radial orientation.

7. Synchronous electric motor with permanent magnets according to claim 6, characterized in that the rotor (5) comprises a head (6) with a central core and arms (8) which extend radially relative to the central core, and in that the arms each comprise on their outer periphery two rims (105) which extend on both sides of the arm (8).

8. Synchronous electric motor with permanent magnets according to claim 7, characterized in that the permanent magnets are accommodated in recesses (7) in the head (6), and in that the recesses (7) are each delimited by two lateral surfaces (112) opposite one another of two adjacent arms (8), an outer surface of the core extending between the two adjacent arms and the rims (105) of the two adjacent arms of the rotor (5).

9. Synchronous electric motor with permanent magnets according to claim 1, characterized in that said permanent magnets are constituted by ferrite.

10. Synchronous electric motor with permanent magnets according to claim 1, characterized in that said head (6) and said casing (3) are each constituted by a stack of plates.

11. Synchronous electric motor with permanent magnets according to claim 1, characterized in that the number of stator teeth (2) is greater than the number of permanent magnets (114).

12. Compressor for a coolant fluid which is designed for an air conditioning installation, characterized in that it comprises a spiral driven by a synchronous electric motor with permanent magnets according to claim 1.

13. Synchronous electric motor with permanent magnets according to claim 2, characterized in that said ratio is predetermined such that said first length (Ls1) is shorter than a third predetermined length (Lm), and electrical performance of said motor, comprising torque and output, is substantially equal to, or greater than predetermined nominal values.

14. Synchronous electric motor with permanent magnets according to claim 2, characterized in that said ratio (r) is predetermined such that a first contribution of a three-dimensional magnetic flux between said stator teeth (2) and said rotor (5) is substantially equal to, or greater than, a second contribution of a two-dimensional magnetic flux in an air gap (9) between a reference stator and a reference rotor, each having said predetermined length (Lm) in an electric reference motor with said predetermined nominal values.

15. Synchronous electric motor with permanent magnets according to claim 3, characterized in that said ratio (r) is predetermined such that a first contribution of a three-dimensional magnetic flux between said stator teeth (2) and said rotor (5) is substantially equal to, or greater than, a second contribution of a two-dimensional magnetic flux in an air gap (9) between a reference stator and a reference rotor, each having said predetermined length (Lm) in an electric reference motor with said predetermined nominal values.

16. Synchronous electric motor with permanent magnets according to claim 2, characterized in that said ratio (r) is also predetermined such as to minimize an increase in weight of said permanent magnets and an increase in material, as well as decreases in production of said head (6) and said casing (3).

17. Synchronous electric motor with permanent magnets according to claim 3, characterized in that said ratio (r) is also predetermined such as to minimize an increase in weight of said permanent magnets and an increase in material, as well as decreases in production of said head (6) and said casing (3).

18. Synchronous electric motor with permanent magnets according to claim 4, characterized in that said ratio (r) is also predetermined such as to minimize an increase in weight of said permanent magnets and an increase in material, as well as decreases in production of said head (6) and said casing (3).
